(19) United States
(12) Patent Application Publication
(10) Pub. No.: US 2026/0094364 A1
(43) Pub. Date: Apr. 2, 2026

(54) SHARING VIRTUAL CONTENT BETWEEN ELECTRONIC DEVICES DURING A COMMUNICATION SESSION

(71) Applicant: Apple Inc., Cupertino, CA (US)

(72) Inventors: Connor A. SMITH, San Jose, CA (US); Gabrielle ECANOW, Santa Clara, CA (US); Anish KANNAN, Sunnyvale, CA (US)

(21) Appl. No.: 19/319,250

(22) Filed: Sep. 4, 2025

Related U.S. Application Data
(60) Provisional application No. 63/700,518, filed on Sep. 27, 2024.

(51) Int. Cl. G06T 17/00

(52) U.S. Cl. CPC G06T 17/00

(57) ABSTRACT

Some examples of the disclosure are directed to a method for sharing virtual content between electronic devices during an active communication session, via a communication application, which allows the sharing of virtual content in scenarios when the electronic device receiving the virtual content has the application corresponding to the virtual content. In some examples, when the electronic device receiving the virtual content does not have the application corresponding to the virtual content, the method further allows the electronic device receiving the virtual content to display a representation of the virtual content with a different application (e.g., the communication application) than the application which corresponds with the virtual content, and thus allows sharing of the virtual content without requiring the electronic device receiving the virtual content to download and/or install the application corresponding to the virtual content.

### CROSS-REFERENCE TO RELATED APPLICATIONS

This application claims the benefit of U.S. Provisional Application No. 63/700,518, filed Sep. 27, 2024, the content of which is incorporated herein in its entirety for all purposes.

### FIELD OF THE DISCLOSURE

This relates generally to systems and methods for sharing virtual content between two or more electronic devices that are communicating within a computer-generated environment (e.g., three-dimensional environment).

### BACKGROUND OF THE DISCLOSURE

Some computer graphical environments provide two-dimensional and/or three-dimensional environments where at least some objects displayed for a user's viewing are virtual and generated by a computer. In some examples, three-dimensional environments are presented by multiple electronic devices in communication with each other. In some examples, a portal through which to visually communicate with a particular user is displayed in a three-dimensional environment presented at a respective electronic device.

### SUMMARY OF THE DISCLOSURE

Some examples of the disclosure are directed to sharing virtual content between users of one or more electronic devices which are communicating within a three-dimensional environment. In some examples, a first electronic device is in communication with one or more displays and one or more input devices, and is in a communication session with a second electronic device. While in a communication session with the second electronic device, the first electronic device optionally displays, via the one or more displays, a visual representation corresponding to a user of the second electronic device in a three-dimensional environment.

While displaying the visual representation corresponding to the user of the second electronic device in the three-dimensional environment, the first electronic device optionally receives, from the second electronic device, a request to display virtual content in the three-dimensional environment, using a first application. After receiving the request from the second electronic device, the first electronic device optionally receives, via the one or more input devices, an input accepting the request. In some examples, in response to receiving the input accepting the request to display the virtual content in the three-dimensional environment using the first application, in accordance with a determination that one or more first criteria are satisfied, the first electronic device displays, via the one or more displays, the virtual content via the first application in the three-dimensional environment. The one or more criteria include a criterion that is satisfied when the first electronic device is configured to display virtual content via the first application. Additionally or alternatively, in some examples, in response to receiving the input accepting the request to display the virtual content in the three-dimensional environment using the first application, in accordance with a determination that the one or more first criteria are not satisfied, the first electronic device displays a representation of at least a portion of the virtual content via a second application, different from the first application, in the three-dimensional environment.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2A-2C illustrates a block diagram of an example architecture for a system according to some examples of the disclosure.

FIG. 3 illustrates an example of a spatial group in a multi-user communication session that includes a first electronic device and a second electronic device according to some examples of the disclosure.

FIG. 4A-FIG. 4O illustrate example methods for communication between electronic devices and sharing virtual content between electronic devices in a three-dimensional environment.

FIG. 5 illustrates a flow diagram illustrating an example process for sharing virtual content between users who are communicating in a three-dimensional environment according to some examples of the disclosure.

### DETAILED DESCRIPTION

Some examples of the disclosure are directed to sharing virtual content between users of one or more electronic devices that are communicating within a three-dimensional environment. In some examples, a first electronic device is in communication with one or more displays and one or more input devices, and is in a communication session with a second electronic device. While in a communication session with the second electronic device, the first electronic device optionally displays, via the one or more displays, a visual representation corresponding to a user of the second electronic device in a three-dimensional environment. While displaying the visual representation corresponding to the user of the second electronic device in the three-dimensional environment, the first electronic device optionally receives, from the second electronic device, a request to display virtual content in the three-dimensional environment, using a first application. After receiving the request from the second electronic device, the first electronic device optionally receives, via the one or more input devices, an input accepting the request. In some examples, in response to receiving the input accepting the request to display the virtual content in the three-dimensional environment using the first application, in accordance with a determination that one or more first criteria are satisfied, the first electronic device displays, via the one or more displays, the virtual content via the first application in the three-dimensional environment. The one or more criteria include a criterion that is satisfied when the first electronic device is configured to display virtual content via the first application. Additionally or alternatively, in some examples, in response to receiving the input accepting the request to display the virtual content in the three-dimensional environment using the first application, in accordance with a determination that the one or more first criteria are not satisfied, the first electronic device displays a representation of at least a portion of the virtual content via a second application, different from the first application, in the three-dimensional environment.

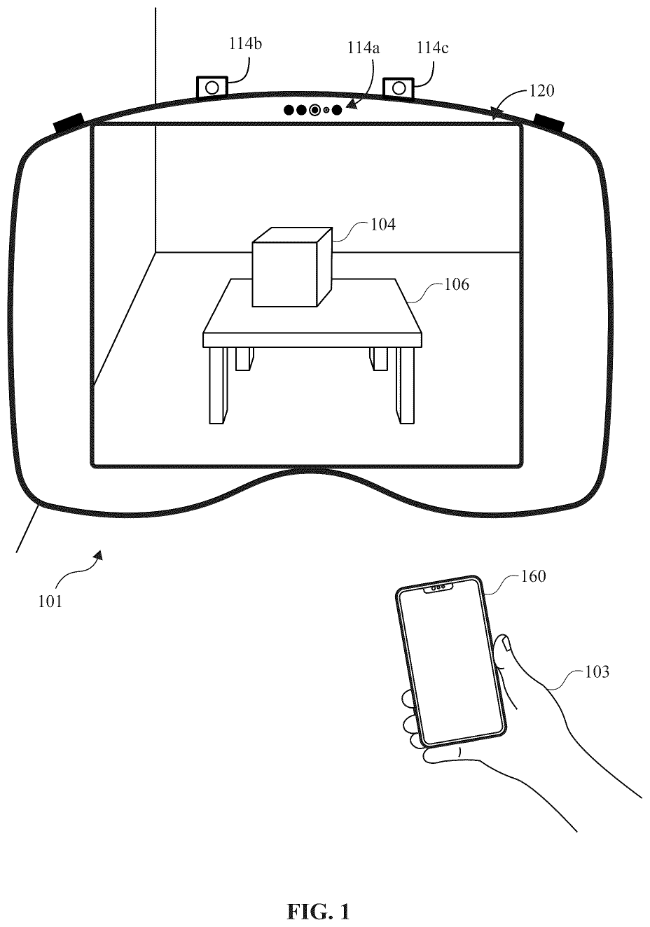

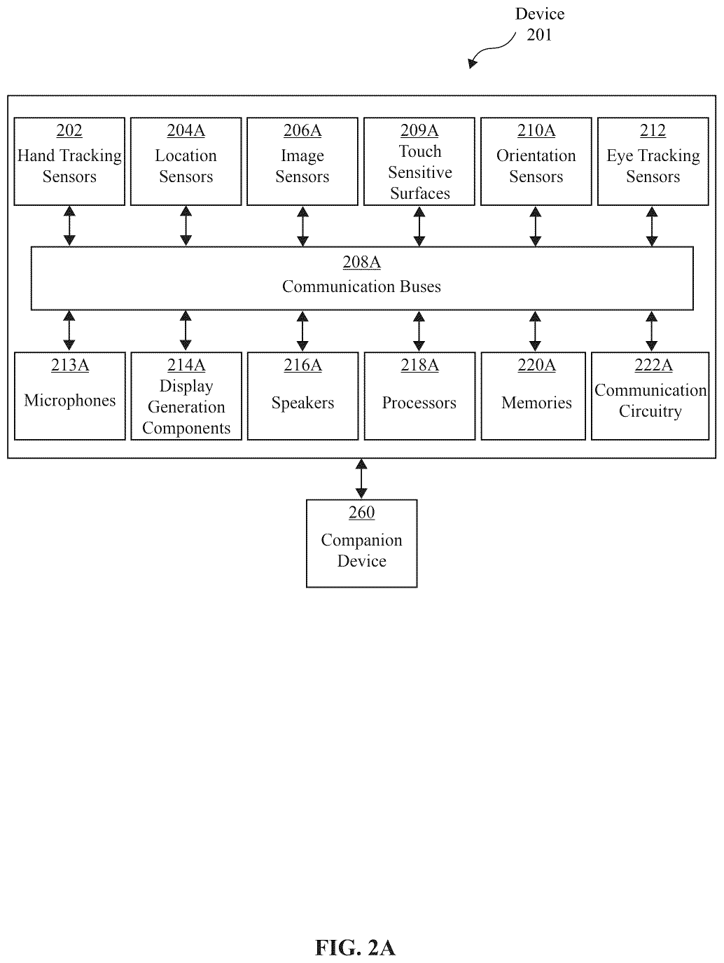

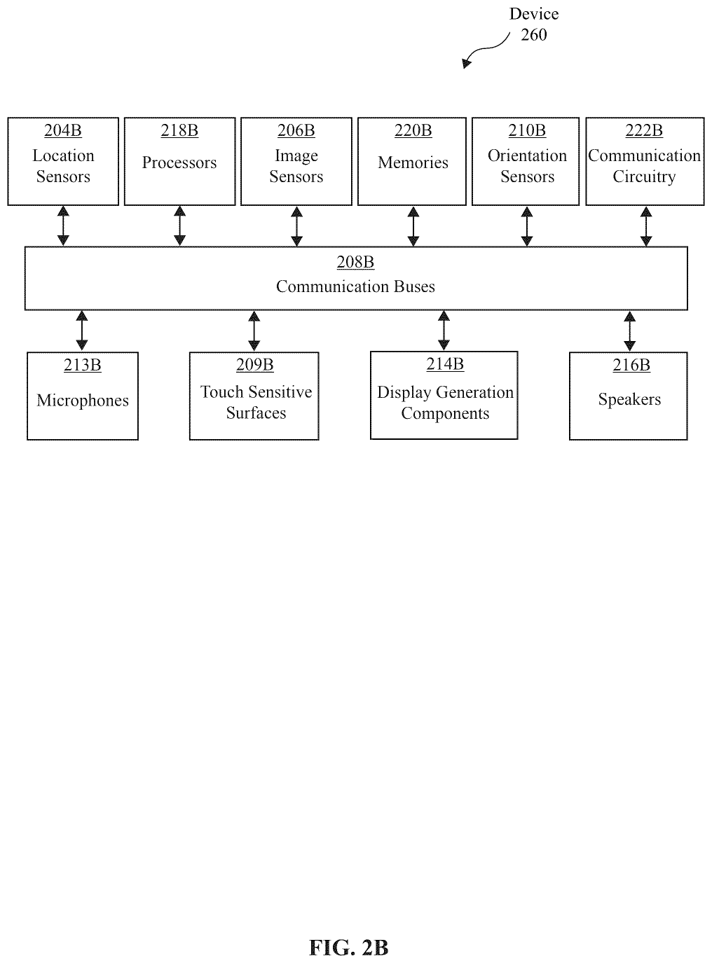

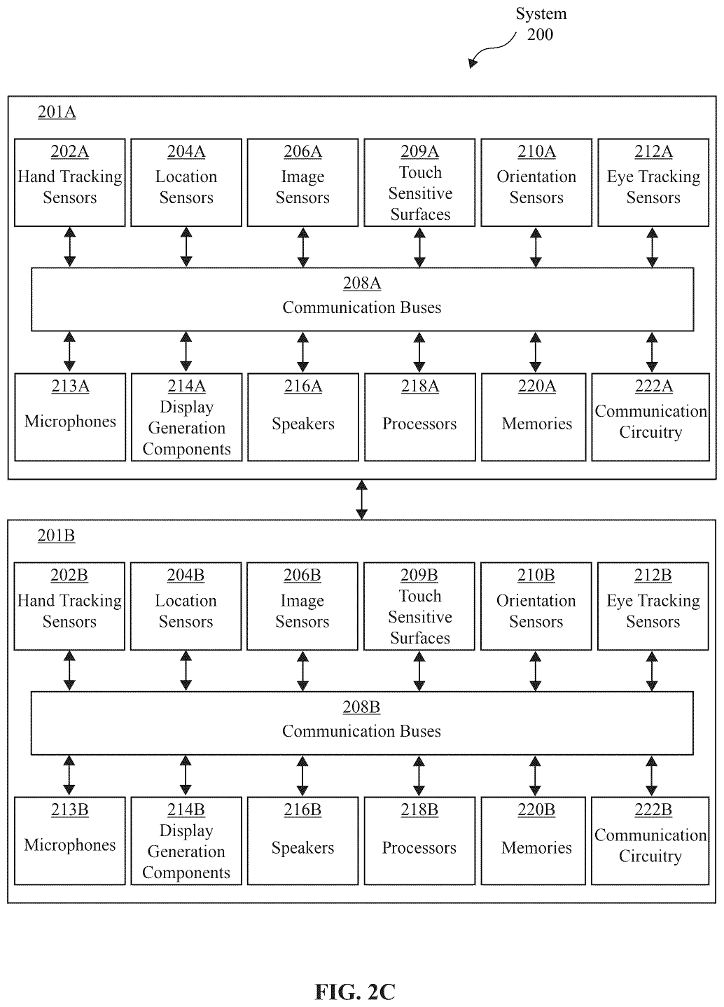

FIG. 1 illustrates an electronic device 101 presenting an extended reality (XR) environment (e.g., a three-dimensional environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A-2C. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2A-2C). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104, in some examples, is a representative virtual object, and one or more different virtual objects (e.g., of various dimensionality such as two-dimensional or other three-dimensional virtual objects) can be included and rendered in a three-dimensional XR environment. For example, the virtual object can represent an application, or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

In some examples, the device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2A-2C illustrates a block diagram of an example architecture for a system 201 according to some examples of the disclosure. In some examples, system 201 includes multiple electronic devices. For example, the system 201 includes a first electronic device 260 and a second electronic device 270, wherein the first electronic device 260 and the second electronic device 270 are in communication with each other. In some examples, the first electronic device 260 and/or the second electronic device 270 are a portable device, an auxiliary device in communication with another device, a head-mounted display, etc., respectively. In some examples, the first electronic device 260 and the second electronic device 270 correspond to electronic device 101 described above with reference to FIG. 1.

In some examples, as illustrated in FIG. 2A-2C, the first electronic device 260 and the second electronic device 270 optionally include various sensors, such as one or more hand tracking sensors 202A/202B, one or more location sensors 204A/204B, one or more image sensors 206A/206B (optionally corresponding to internal image sensors 114a and/or external image sensors 114b and 114c in FIG. 1), one or more touch-sensitive surfaces 209A/209B, one or more motion and/or orientation sensors 210A/210B, one or more eye tracking sensors 212A/212B, one or more microphones 213A/213B or other audio sensors, one or more body tracking sensors (e.g., torso and/or head tracking sensors), one or more display generation components 214A/214B, optionally corresponding to display 120 in FIG. 1, one or more speakers 216A/216B, one or more processors 218A/218B, one or more memories 220A/220B, and/or communication circuitry 222A/222B. One or more communication buses 208A/208B are optionally used for communication between the above-mentioned components of the electronic devices 260 and 270.

In some examples, communication circuitry 222A/222B optionally includes circuitry for communicating with electronic devices, networks, such as the Internet, intranets, a wired network and/or a wireless network, cellular networks, and wireless local area networks (LANs). Communication circuitry 222A/222B optionally includes circuitry for communicating using near-field communication (NFC) and/or short-range communication, such as Bluetooth®.

In some examples, processor(s) 218A/218B include one or more general processors, one or more graphics processors, and/or one or more digital signal processors. In some examples, memory 220A/220B is a non-transitory computer-readable storage medium (e.g., flash memory, random access memory, or other volatile or non-volatile memory or storage) that stores computer-readable instructions configured to be executed by processor(s) 218A/218B to perform the techniques, processes, and/or methods described below. In some examples, memory 220A/220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A/214B include a single display (e.g., a liquid-crystal display (LCD), organic light-emitting diode (OLED), or other types of display). In some examples, display generation component(s) 214A/214B include multiple displays. In some examples, display generation component(s) 214A/214B can include a display with touch capability (e.g., a touch screen), a projector, a holographic projector, a retinal projector, a transparent or translucent display, etc. In some examples, the first electronic devices 260 and second electronic device 270 include touch-sensitive surface(s) 209A/209B, respectively, for receiving user inputs, such as tap inputs and swipe inputs or other gestures. In some examples, display generation component(s) 214A/214B and touch-sensitive surface(s) 209A/209B form touch-sensitive display(s) (e.g., a touch screen integrated with electronic devices 260 and 270 or external to electronic devices 260 and 270 that is in communication with electronic devices 260 and 270).

In some examples, electronic devices 260 and 270 optionally include image sensor(s) 206A/206B. Image sensors(s) 206A/206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic devices 260 and 270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic devices 260 and 270 use image sensor(s) 206A/206B to detect the position and orientation of electronic devices 260 and 270 and/or display generation component(s) 214A/214B in the real-world environment. For example, electronic devices 260 and 270 use image sensor(s) 206A/206B to track the position and orientation of display generation component(s) 214A/214B relative to one or more fixed objects in the real-world environment.

In some examples, electronic devices 260 and 270 include microphone(s) 213A/213B or other audio sensors. Electronic devices 260 and 270 optionally use microphone(s) 213A/213B to detect sound from the user and/or the real-world environment of the user. In some examples, microphone(s) 213A/213B include an array of microphones (a plurality of microphones) that optionally operate in tandem, such as to identify ambient noise or to locate the source of sound in space of the real-world environment.

In some examples, electronic devices 260 and 270 include location sensor(s) 204A/204B for detecting a location of electronic devices 260 and 270 and/or display generation component(s) 214A/214B. For example, location sensor(s) 204A/204B can include a global positioning system (GPS) receiver that receives data from one or more satellites and allows electronic devices 260 and 270 to determine the devices'absolute positions in the physical world.

In some examples, electronic devices 260 and 270 include orientation sensor(s) 210A/210B for detecting orientation and/or movement of electronic devices 260 and 270 and/or display generation component(s) 214A/214B. For example, electronic devices 260 and 270 use orientation sensor(s) 210A/210B to track changes in the position and/or orientation of electronic devices 260 and 270 and/or display generation component(s) 214A/214B, such as with respect to physical objects in the real-world environment. Orientation sensor(s) 210A/210B optionally include one or more gyroscopes and/or one or more accelerometers.

In some examples, electronic devices 260 and 270 include hand tracking sensor(s) 202A/202B and/or eye tracking sensor(s) 212A/212B (and/or other body tracking sensor(s), such as leg, torso and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

In some examples, electronic devices 260 and 270 are not limited to the components and configuration of FIG. 2A-2C, but can include fewer, other, or additional components in multiple configurations. In some examples, system 201 can be implemented in a single device. A person or persons using electronic devices 260/270, is optionally referred to herein as a user or users of the device(s).

Attention is now directed towards interactions between users who are communicating in a multi-user communication session. In some examples, the users are communicating using portals and/or windows or other user interface elements displayed in a three-dimensional environment presented at one or more electronic devices (e.g., corresponding to electronic devices 260 and 270). In some examples, as described below, a portal corresponds to a virtual object (e.g., a two-dimensional or three-dimensional virtual object) presented by an electronic device that enables a user of the electronic device to visually communicate with another user. For example, the portal includes a representation (e.g., computer-generated representation) of the other user. In some examples, as described below, a window corresponds to a virtual object associated with an application and/or viewport through which content originating at a second electronic device, is shared with a first electronic device, to allow co-viewing and/or co-interaction with virtual content displayed therewith. As discussed below, when displaying the portal that includes the representation of the other user in the three-dimensional environment, it may be desirable to provide systems and methods for enabling the sharing of virtual content between the users (e.g., via their respective representations in their respective portals). Sharing virtual content between users displayed in a three-dimensional environment allows remote interaction between users in a manner which simulates physical copresence between a plurality of users in near proximity and/or disparate locations, enabling interaction previously requiring physical copresence (e.g., board game play).

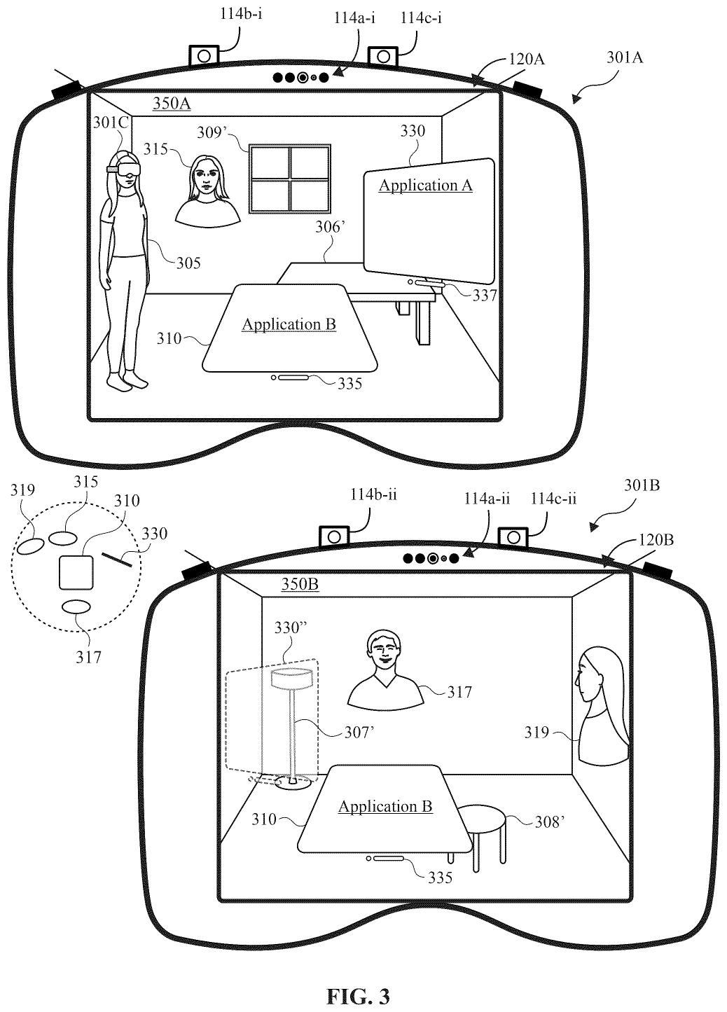

FIG. 3 illustrates an example of a spatial group 340 in a multi-user communication session that includes a first electronic device 360 and a second electronic device 370 according to some examples of the disclosure. In some examples, the first electronic device 360 may present a three-dimensional environment 350A, and the second electronic device 370 may present a three-dimensional environment 350B. The first electronic device 360 and the second electronic device 370 may be similar to electronic device 101 or 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

In some examples, as shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306 and a representation of the window 309. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307 and a representation of the coffee table 308. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or otherwise visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three-dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306 and/or the avatar 315 (e.g., because the user of the first electronic device 360 moved forward in the physical environment surrounding the first electronic device 360), the viewpoint of the three-dimensional environment 350A would change accordingly, such that the representation of the table 306, the representation of the window 309 and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are representations (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are user-personalized, user-selected, and/or user-created representations displayed in the three-dimensional environments 350A/350B that are representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, in some examples, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment. For example, as shown in FIG. 3, the three-dimensional environments 350A/350B include a shared virtual object 310 (e.g., which is optionally a three-dimensional virtual sculpture) that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

As mentioned previously above, in some examples, the user of the first electronic device 360 and the user of the second electronic device 370 are in a spatial group 340 within the multi-user communication session. In some examples, the spatial group 340 may be a baseline (e.g., a first or default) spatial group within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial group 340 within the multi-user communication session. In some examples, while the users are in the spatial group 340 as shown in FIG. 3, the user of the first electronic device 360 and the user of the second electronic device 370 have a first spatial arrangement (e.g., first spatial template) within the shared three-dimensional environment. For example, the user of the first electronic device 360 and the user of the second electronic device 370, including objects that are displayed in the shared three-dimensional environment, have spatial truth within the spatial group 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

In some examples, while in a communication session together, the user of a second electronic device may want to share virtual content and/or interact with virtual content with the user of a first electronic device. In some examples, sharing virtual content between multiple electronic devices includes each electronic device having an application corresponding to the shared virtual content. For example, when the shared virtual content is a game, each electronic device includes the game application in respective memory and executes the game application using the respective processor or processors to present and provide interaction opportunities with the application. As another example, when the shared virtual content is a video, each electronic device includes the video application in respective memory and executes the video application using the respective processor or processors to present and provide interaction opportunities with the application. The game and video applications are non-limiting examples of shared virtual content and applications.

While it is advantageous for each electronic device to have stored (e.g., via memory 220A) a first application (e.g., a virtual content application) that is configured for the viewing and interacting with the virtual content to be shared, it may be advantageous to allow the respective user at the respective electronic device to view and/or interact with the shared virtual content without requiring the respective electronic device to have and execute the first application. In some examples, it may be advantageous for the first electronic device, in absence of the first application, to allow the first user to interact and/or view the virtual content via a second application (e.g., the communication application facilitating the multi-user communication session, or alternate viewing application) without requiring the download, installation, and/or execution of the first application at the first electronic device. By allowing the first electronic device to display and/or allow the first user to interact with the virtual content without requiring the first application, the sharing of virtual content is more streamlined and consistent without the interruption of requiring the download, storing, installation, or execution of the first application.

For example, when the second electronic device shares a virtual chess game which is played on a virtual chess application with the first electronic device, and the first electronic device has the virtual chess application installed, each user at their respective electronic device is able to present the virtual chess game via the virtual chess application and each user at their respective electronic device is able to interact with the chess game in a manner which simulates playing a physical chess game on a physical chess board. However, when the second electronic device shares a virtual chess game which is played on a virtual chess application with the first electronic device, and the first electronic device does not have the virtual chess application installed, the systems and method described herein enable the user of the first electronic device to still view a representation of the virtual chess game, and optionally allows the first user to view and/or at least partially interact with the representation of the virtual chess game (or interact in different ways than would be enabled by presenting the virtual chess game via the virtual chess application).

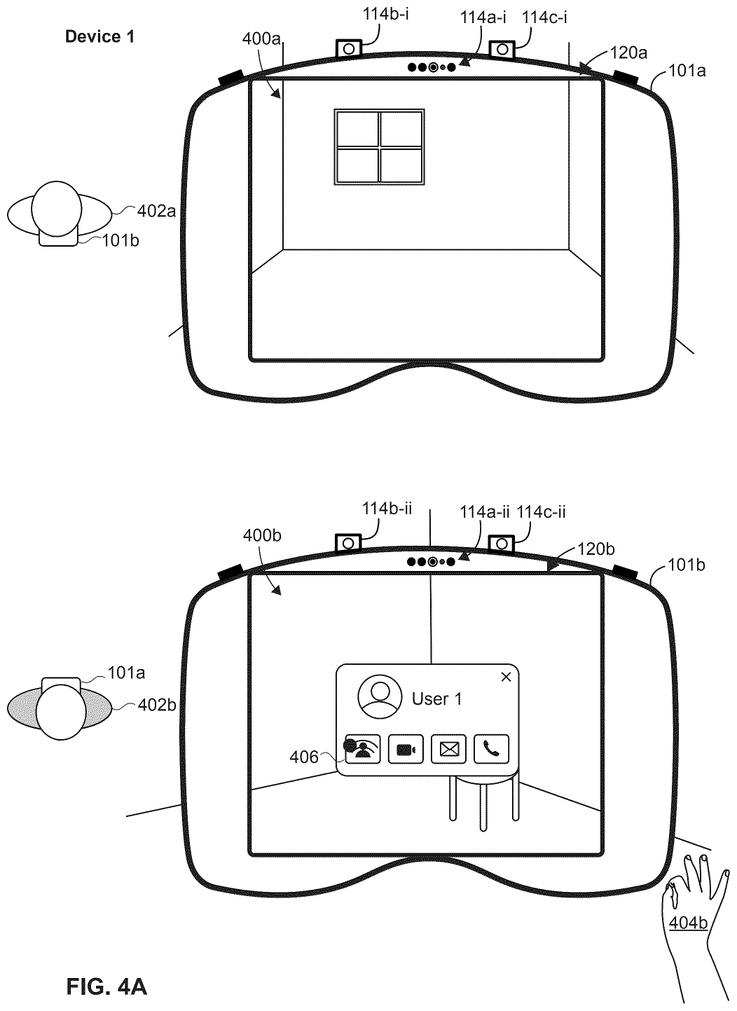

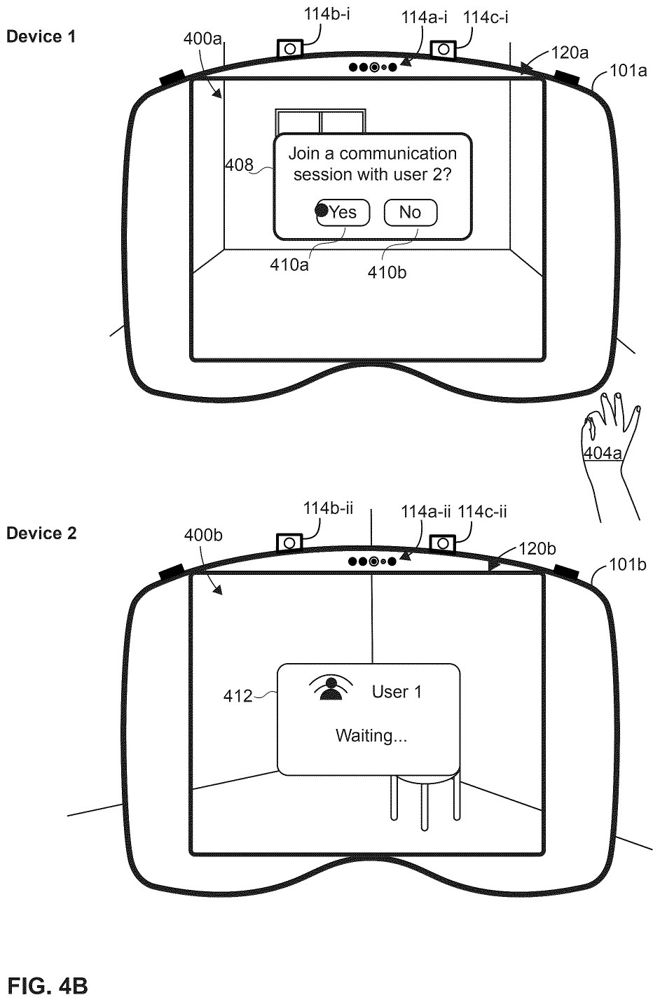

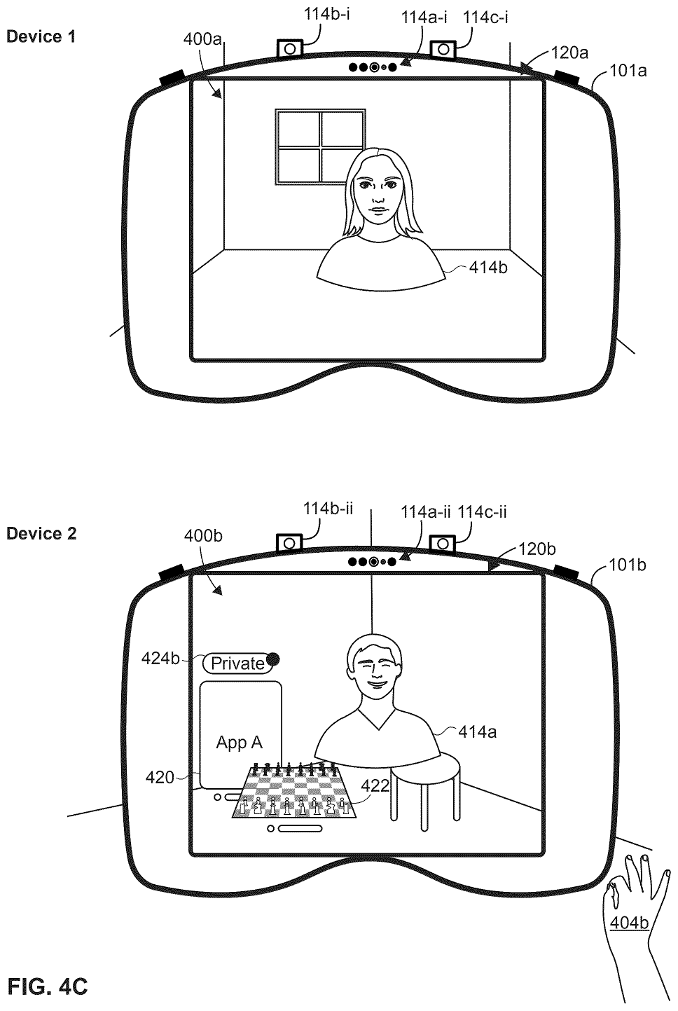

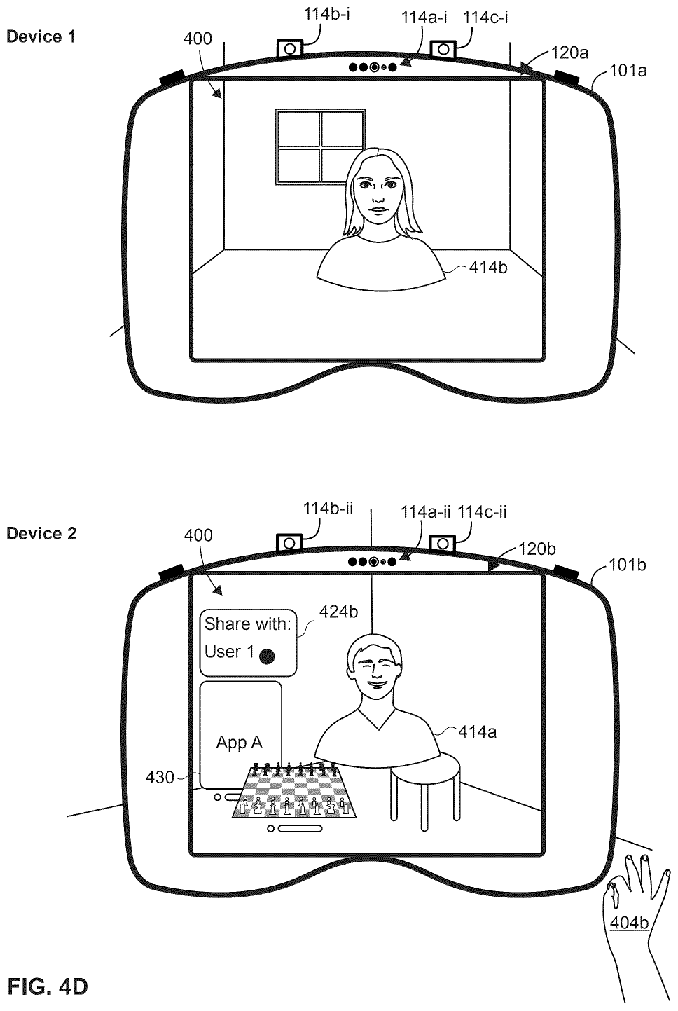

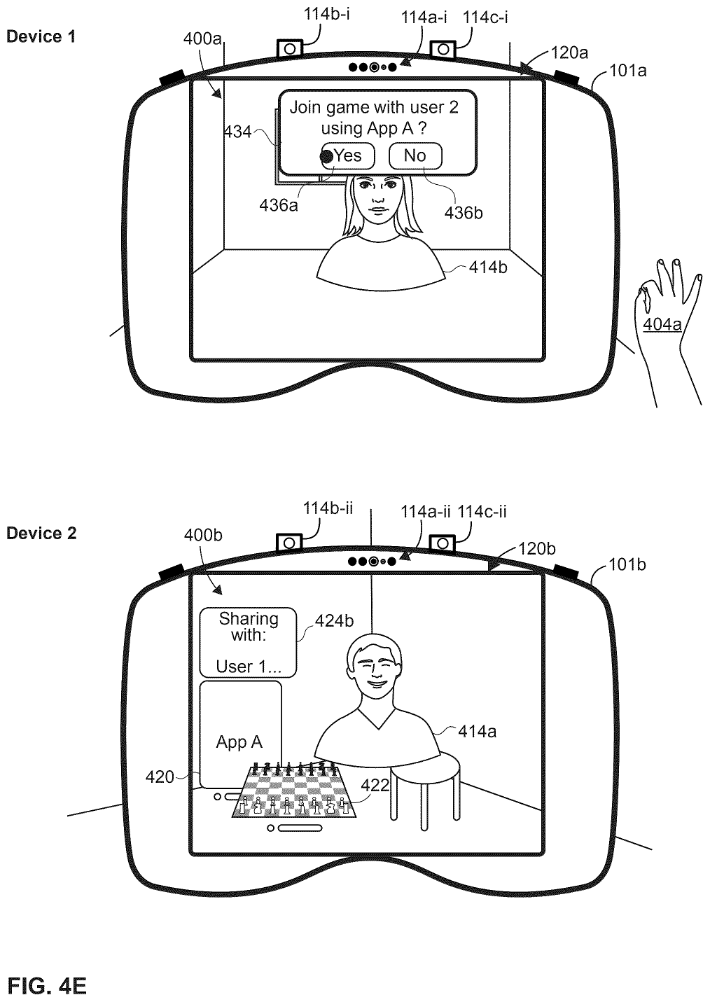

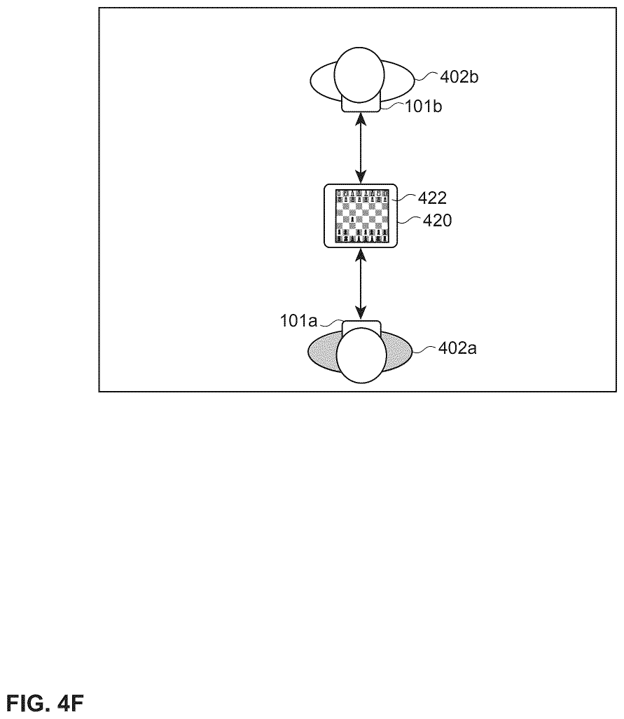

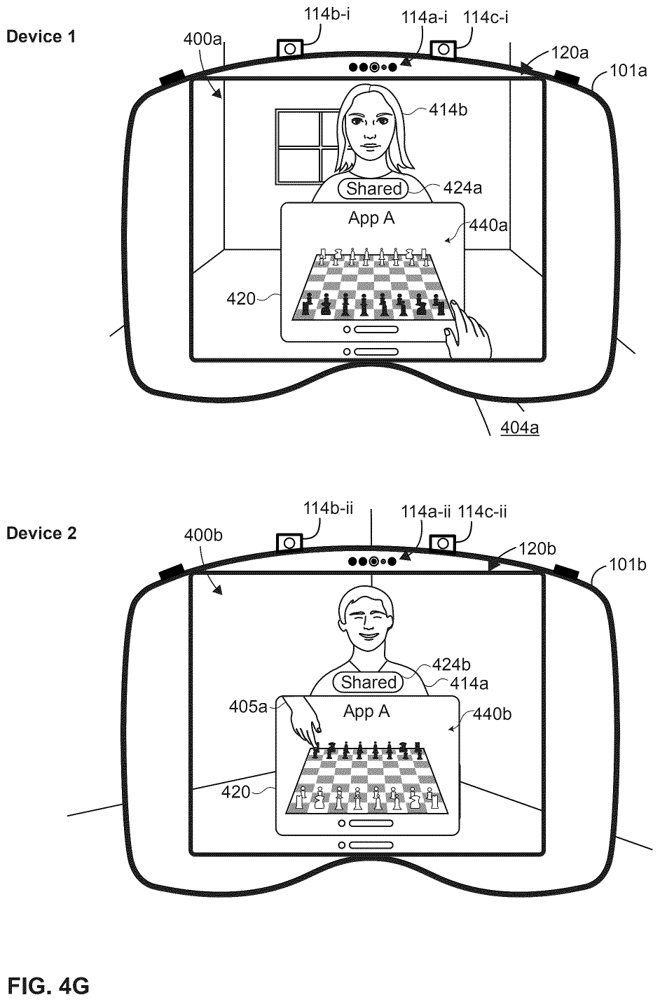

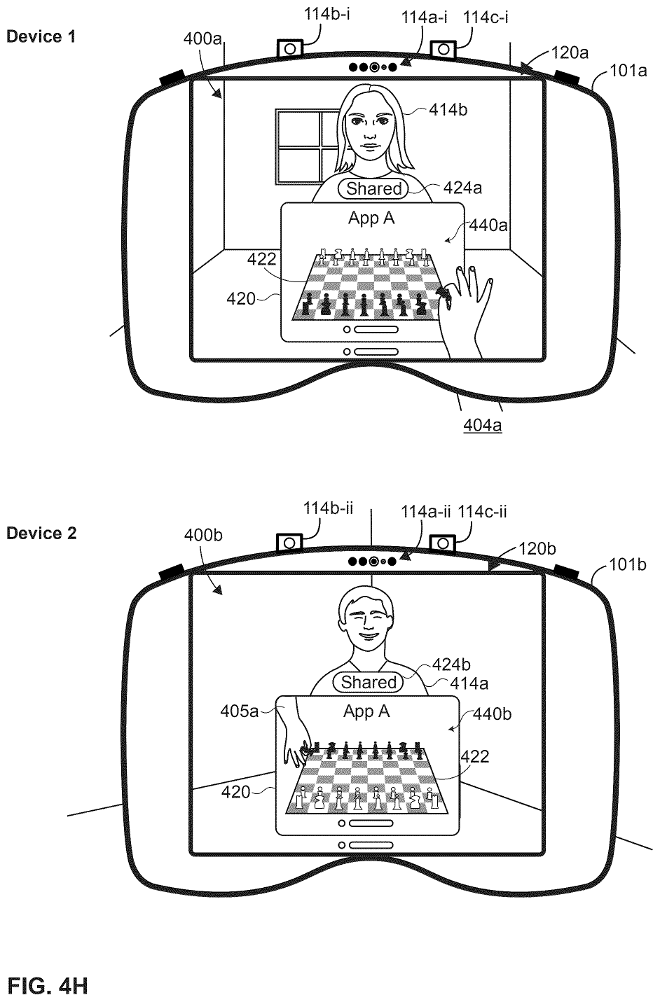

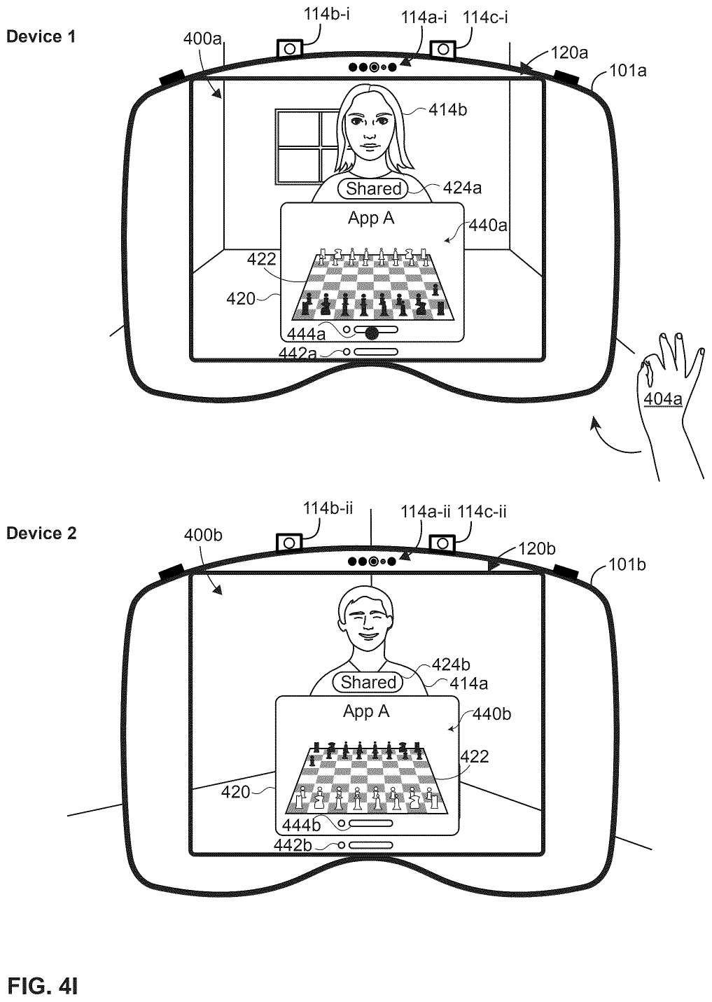

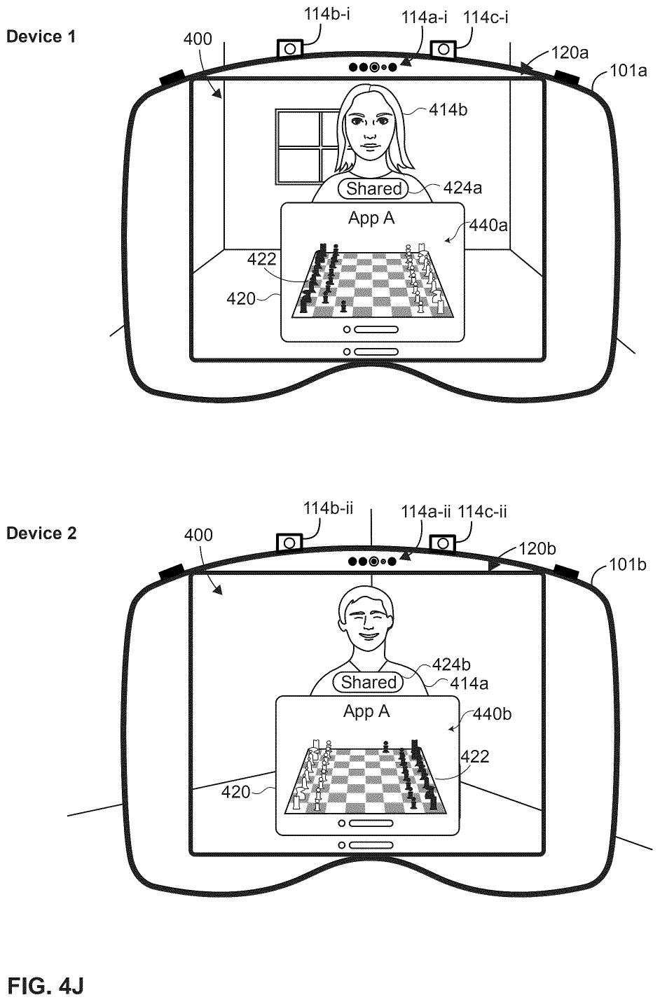

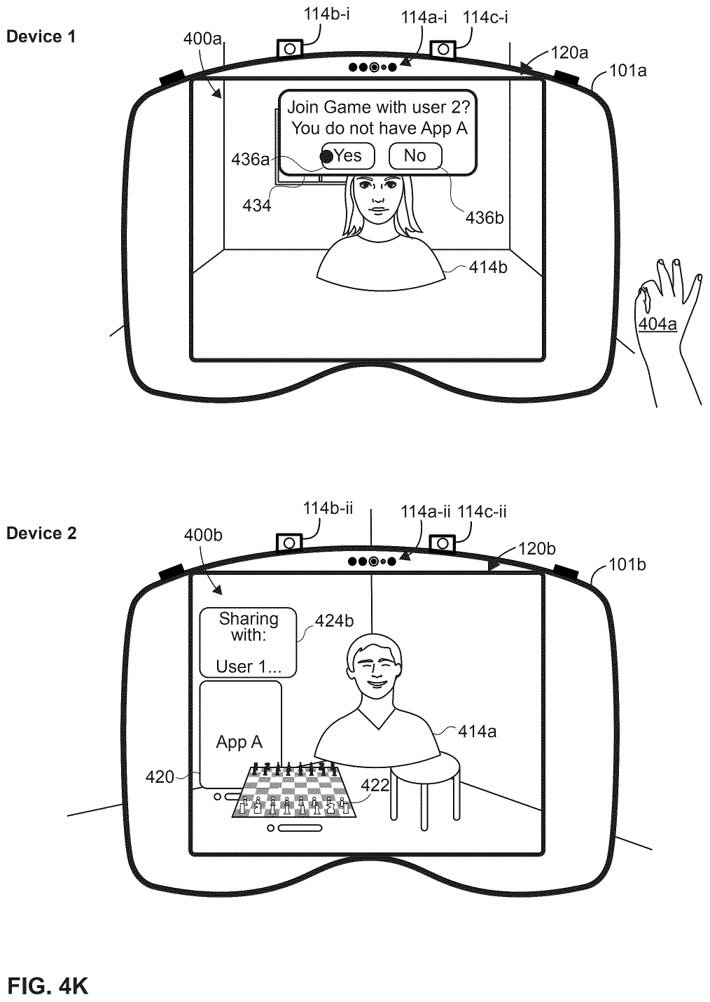

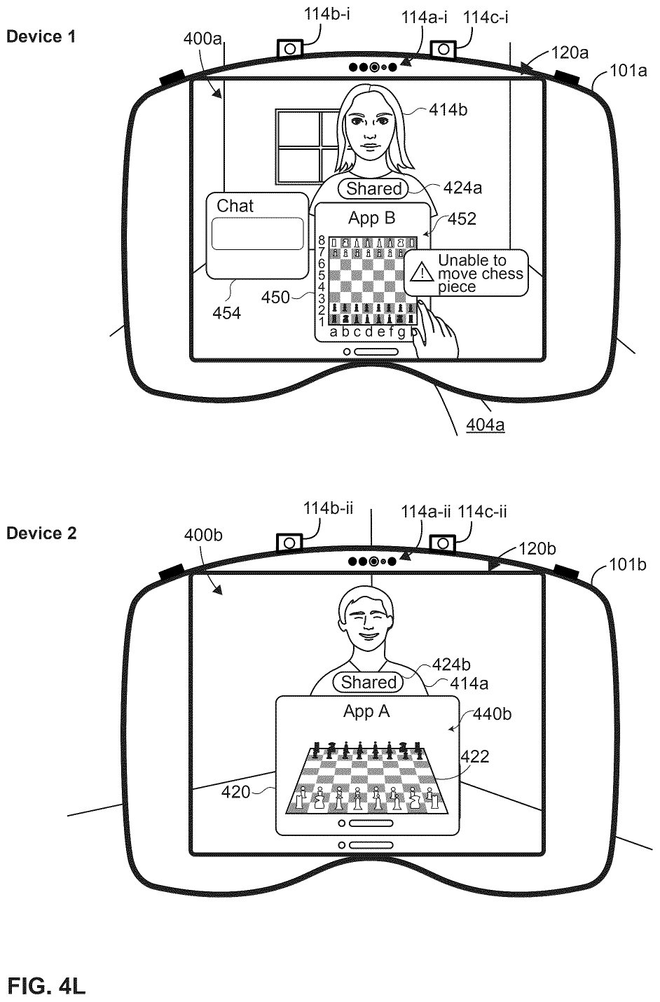

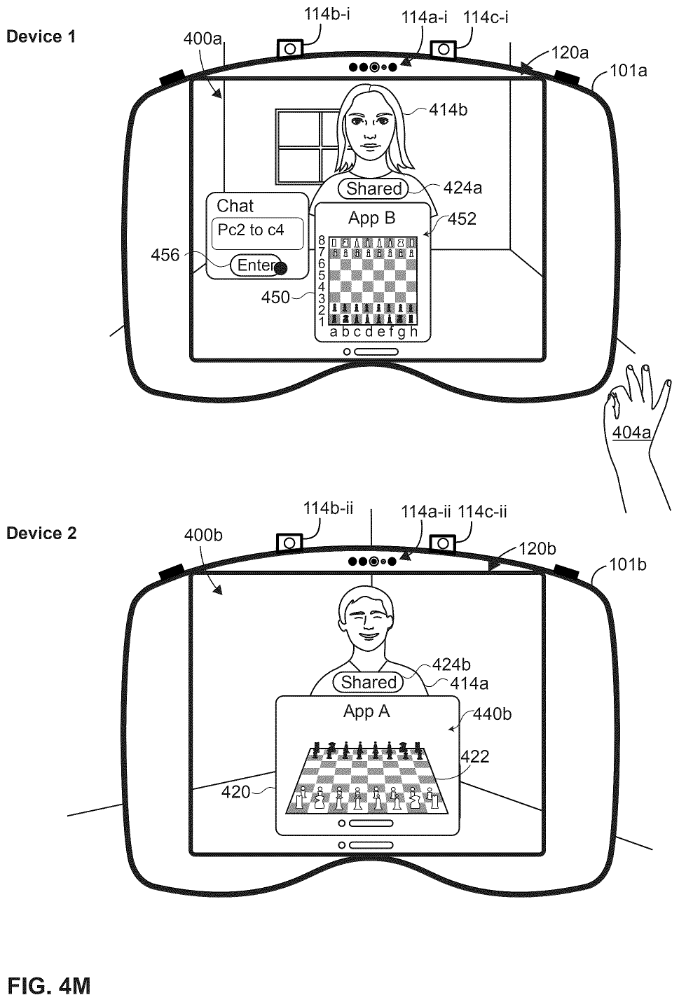

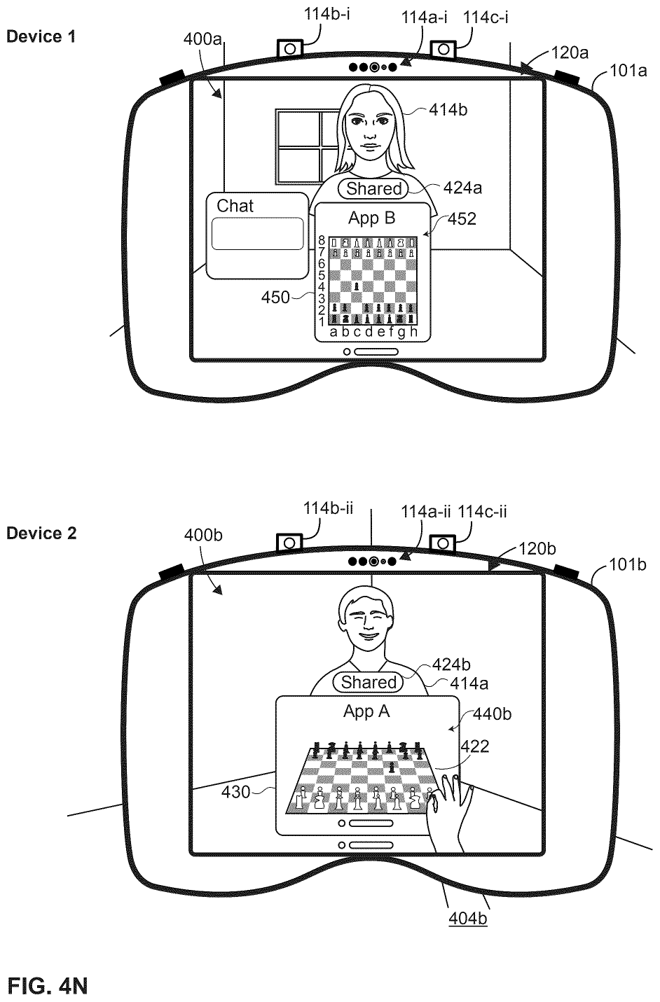

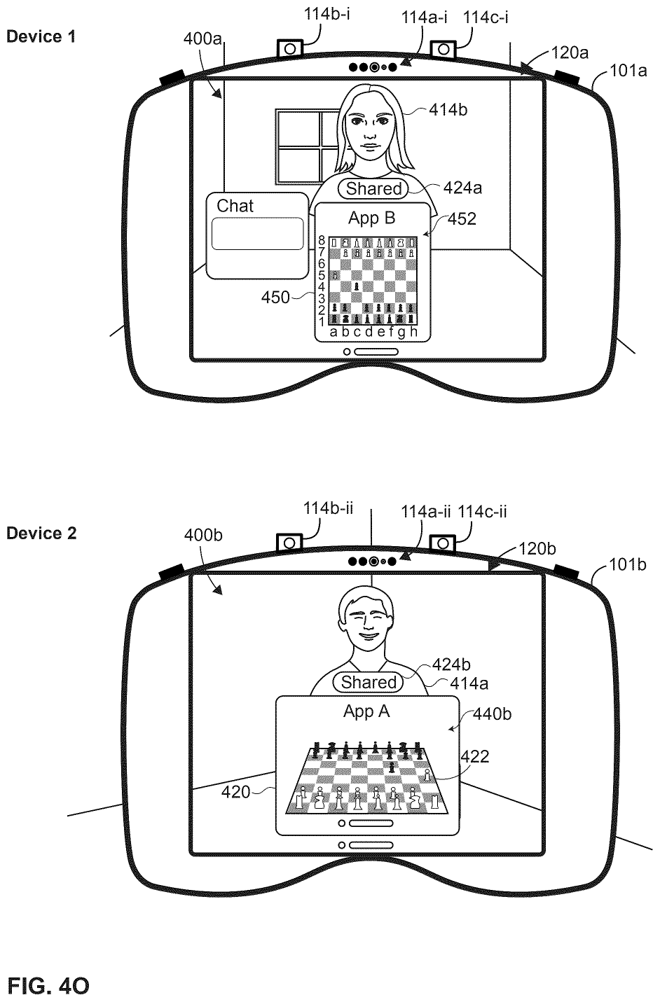

In some examples, as illustrated in FIG. 4A for instance, a first electronic device 101a (e.g., corresponding to or similar to first electronic device 260 at FIG. 2A-2C) and a second electronic device 101b (e.g., corresponding to or similar to second electronic device 270 at FIG. 2A-2C) are in different physical locations within one or more physical environments. The first electronic device 101a optionally presents, via one or more displays 120a, a representation of physical environment 400a of the first electronic device 101a. The second electronic device 101b optionally presents, via one or more displays 120b, a representation of the physical environment 400b of the second electronic device. Additionally or alternatively, the electronic devices each optionally display a computer-generated environment and/or a computer-generated elements within the respective representation of the physical environments.

In some examples, as shown in FIG. 4A, the second electronic device 101b detects input (e.g., gesture by hand 404b) from the second user 402b at the second electronic device 101b to initiate inviting the first user 402a at the first electronic device, to a communication session, such as when the second electronic device 101b detects the attention of the second user (e.g., via gaze, and/or gesture from hand 404b of the second user) directed to a user interface element 406 corresponding to initiating a communication session with the first user 402a at the first electronic device 101a. In some examples, as illustrated in FIG. 4B, in response to detecting the input of the second user 402b corresponding to the invitation of the first user to a communication session, the second electronic device sends a request 408 to the first electronic device 101a including a request to initiate the communication session via a communication application. In some examples, the first electronic device 101a displays the request 408 including a user interface element 410a which, when selected, corresponds to accepting the request, and a user interface element 410b which, when selected, corresponds to rejecting the request. In some examples, while the second electronic device 101b awaits a response to the request from the first electronic device 101a, the second electronic device 101b optionally displays a user interface element 412 indicating that a response has not been received from the first electronic device 101a. After the first electronic device 101a receives an input (e.g., gesture from a hand 404a of the first user) from the first user 402a corresponding to accepting the invitation to initiate the communication session, a visual representation 414b of the second user 402b (e.g., an avatar, image, icon, name, or other signifier) is displayed, via the one or more displays, at the first electronic device 101a, and a visual representation 414a of the first user 402a is displayed, via the one or more displays, at the second electronic device 101b, as shown in FIG. 4C.

In some examples, while the first electronic device 101a is in a communication session (e.g., video call) with the second electronic device 101b, the second electronic device 101b optionally displays a shared three-dimensional environment which is viewable via one or more displays of the first electronic device. For instance, a user at the first electronic device 101a is able to view the three-dimensional environment displayed (e.g., shared) by the second electronic device, via the one or more displays of the first electronic device. Additionally or alternatively, the three-dimensional environment displayed at each electronic device corresponds to a representation of the physical environment of the respective user, optionally including a representation of the one or more other users which are participating within the communication session (e.g., overlaid on the representation of the physical environment). For instance, the three-dimensional environment displayed at the first electronic device 101a optionally includes a representation of the physical environment of the first user 402a (e.g., including a representation of a physical window) and includes an avatar (e.g., visual representation 414b) corresponding to the user of the second electronic device 101b. An avatar optionally includes a virtual representation which resembles the user of the second electronic device, such as an animated virtual representation which mirrors the physical traits, motions, and/or expressions of the user. Additionally or alternatively, an avatar optionally includes a virtual representation of a person, place, and/or thing which is predetermined and/or selected by the respective user (e.g., user of the second electronic device).

In some examples, as shown in FIG. 4C, the second electronic device 101b displays, via the one or more displays 120b, virtual content 422 via a first application 420 (e.g., a virtual content application), wherein the virtual content 422 (e.g., a chess game) is privately viewed by the second user 402b at the second electronic device 101b, and the virtual content 422 is therefore not visible to the first user 402a at the first electronic device 101a. In some examples, a user interface element (e.g., status identifier) 424b displayed at the second electronic device 101b indicates that the virtual content is private and therefore not shared in the communication session. In some examples, when the second electronic device 101b detects an input (e.g., gesture from a hand 404b of the second user) via a user interface element (e.g., status identifier 424b) corresponding to a request to initiate sharing of the virtual content 422, the second electronic device 101b displays, via the one or more displays of the second electronic device, a user interface element for sharing the virtual content 422, corresponding to a request to share the virtual content 422, as shown in FIG. 4D. Additionally or alternatively, in some examples, the first electronic device 101a, based on an input from the first user 402a, optionally sends a request to the second electronic device to view and/or participate in virtual content which is displayed at the second electronic device. In some examples, a plurality of electronic devices are able to send a request to an electronic device (e.g., the second electronic device) which is displaying virtual content via the first application. It should be understood that, while the status identifier 424b in FIG. 4D indicates the ability of the second electronic device 101b to share the virtual content 422 with the first user (e.g., User 1) at the first electronic device 101a, the status identifier 424b may additionally or alternatively include visual indications of other users (e.g., of other electronic devices) with whom the virtual content 422 is able to be shared. For example, if the multi-user communication session also include a third electronic device (e.g., associated with a third user (not shown)), the status identifier 424b may include a visual indication corresponding to the third user that is selectable to share the virtual content 422 with the third user (e.g., in addition or instead of sharing the virtual content 422 with the first user as discussed above).

When the second electronic device 101b detects a user input (e.g., gesture from a hand 404b of the second user) corresponding with requesting to share the virtual content 422 with the first electronic device via the user interface element (e.g., status identifier 424b), the second electronic device optionally sends a request 434 to share (at FIG. 4E) to the first electronic device 101a, wherein the first electronic device 101a displays the request 434 to share, which optionally includes a user interface element 436a corresponding to accepting the request to share, and a user interface element 436b corresponding to rejecting the request to share. While the request 434 to share is displayed at the first electronic device 101a, the first electronic device 101a optionally detects an input (e.g., gesture by hand 404a) from the first user corresponding to accepting the request to share the virtual content (e.g., selection of the user interface element 436a), as shown in FIG. 4E. In some examples, if the first electronic device 101a does not have the first application 420 open or installed at the time of receiving the request 434 to share the virtual content 422, the first electronic device 101a displays, via the one or more displays 120a, one or more selectable user interface elements which allow the first user at the first electronic device 101a to open and/or download the first application 420.

In some examples, when the first electronic device 101a receives a request 434 from the second electronic device 101b, such as illustrated in FIG. 4E and FIG. 4K, the request is displayed at the first electronic device 101a dependent upon satisfaction of one or more criteria at the first electronic device 101a. When the first electronic device 101a is configured to display, via the first application, the shared virtual content 422 (in FIG. 4E), thereby satisfying the one or more criteria, the first electronic device 101a optionally displays the request 434 with one or more first visual characteristics. When the first electronic device 101a is not configured to display, via the first application, the shared virtual content 422 (FIG. 4K), the first electronic device 101a optionally displays the request 434 with one or more second visual characteristics, wherein at least one of the one or more second visual characteristics are different than the one or more first visual characteristics. The one or more first visual characteristics, and the one or more second visual characteristics, optionally correspond to color, content, location, brightness, presentation size, etc. Additionally or alternatively, in some examples, in response to receiving the input to accept the request 434 by the first user, the first electronic device 101a performs the operation to display the virtual content 422 via the first application 420, or to display the representation of the virtual content 452 via the second application 450, depending upon the configuration of the first electronic device 101a when the request 434 is received.

In some examples, when the first electronic device receives an input (e.g., attention of the first user, and/or gesture from a hand 404a of the first user) directed to the user interface element 436a corresponding to the acceptance of the request 434 (at FIG. 4E), the first electronic device 101a optionally displays the virtual content 422 at the first electronic device via the first application. Prior to acceptance of the request sent to the first electronic device, the virtual content remains privately displayed at the second electronic device 101b, wherein a status identifier 424b indicates that the virtual content remains private. Once the second electronic device 101b receives an indication that the request to share the virtual content has been accepted at the first electronic device 101a, the status identifier 424b optionally indicates that the virtual content has been shared with the first electronic device 101a. Additionally or alternatively, the status identifier optionally indicates that the virtual content has been shared with the first electronic device upon sending the request 434 to the first electronic device.

In some examples, the second user 402b at the second electronic device 101b is able to share the virtual content 422 with the first user at the first electronic device 101a. For instance, as shown in FIG. 4F, the virtual content 422 corresponding with a chess game is shared from the second electronic device 101b to the first electronic device 101a. Additionally or alternatively, in some examples, the virtual content 422 is able to be shared with one or more other electronic devices (e.g., a third electronic device, and/or a fourth electronic device) alternatively and/or simultaneously. In some examples, when display of the virtual content 422 is enabled between multiple electronic devices (e.g., as shown in FIG. 4F), the virtual content 422 is shared by the second electronic device 101b (e.g., and therefore is assigned a sharer role) and viewed and/or participated in (e.g., and therefore is assigned a participant role) by the first electronic device 101a. In some examples, the role of sharer and the role of participant is able to be transferred between electronic devices when an input is detected at an alternate electronic device (e.g., the first electronic device, the third electronic device, the fourth electronic device, etc.) corresponding to a request to share the virtual content 422. For example, the role of sharer can be transferred from the second electronic device 101b to the alternative electronic device (e.g., the first electronic device 101a, the third electronic device, the fourth electronic device, etc.), whereby the role of participating and/or viewing is transferred to the second electronic device 101b (e.g., which was previously sharing the virtual content 422).

In some examples, when the request to display the virtual content is accepted by the first electronic device 101a, and the first electronic device 101a includes the first application (e.g., App A in FIG. 4C), optionally stored in memory 220A (FIG. 2A-2C), the virtual content 422 is displayed via the first application on the first electronic device 101a, as shown in FIG. 4F, wherein the user of the first electronic device is able to interact with the virtual content through the first application. For instance, in the example of an immersive chess game, when displayed on the first electronic device 101a via the first application, the user of the first electronic device is able to interact with (e.g., select, move, play, change point of view of the user, etc.) the immersive chess game in a manner which is viewable via the first electronic device 101a and the second electronic device 101b. The use of the first application optionally allows immersive environments and/or immersive content to be shared in a manner which the user of the first electronic device 101a is able to directly enter and/or interact with the virtual content.

In some examples, displaying the virtual content 422 includes displaying the virtual content via a portal, such as shown in top-down view 410 in FIG. 4F, which is displayed in conjunction with and/or instead of the representation of the physical environment 400a corresponding to the first electronic device at the first electronic device and the representation of the physical environment 400b corresponding to the second electronic device at the second electronic device. When the virtual content 422 displayed via the first application 420 within the portal, the first user 404 at the first electronic device 101a and the second user 402b at the second electronic device 101b, are optionally immersed within a shared three-dimensional environment such as illustrated in FIG. 4F. When immersed within the portal, the three-dimensional environment optionally corresponds to a computer-generated environment wherein the representations of the respective users are displayed accordingly within the portal. For instance, when immersed within a three-dimensional environment of the portal, the first electronic device optionally displays a first view of the three-dimensional environment within the portal which includes a visual representation 414b of the second user 402b and the virtual content 422 displayed via the first application 420 between the visual representation 414b of the second user 402b and the location corresponding to the first electronic device 101a. Similarly, when immersed within a three-dimensional environment of the portal, the second electronic device 101b optionally displays a second view of the three-dimensional environment within the portal, different from the first view of the three-dimensional environment within the portal, which includes a representation of the first user 404 and the virtual content 422 displayed via the first application 420 between the representation of the first user 404 and the location corresponding to the second electronic device 101b. In some examples, the virtual content is displayed within a portal which corresponds to a window, such as shown in FIG. 4G, which is displayed in a manner which obscures at least a portion of the respective three-dimensional environment corresponding to the representation of each respective user, wherein the respective users are able to interact with the virtual content 422 within the portal.

In some examples, as illustrated in FIG. 4G-FIG. 4J, when the virtual content is shared from the second electronic device 101b to the first electronic device 101a, the virtual content (such as a chess game) is displayed via the first application 420, which optionally includes a portal, and which obscures at least a portion of the three-dimensional environment as viewed from each respective electronic device. For instance, as seen in FIG. 4G, the first electronic device 101a optionally displays, via the one or more displays 120a, the virtual content within the first application including a portal 440a which provides a view of the virtual content from a first perspective (e.g., a first viewpoint), wherein the portal 440a obscures at least a portion of the representation of the physical environment 400a of the first electronic device 101a. Similarly, the second electronic device 101b optionally displays, via the one or more displays 120b, the virtual content within a portal 440b which provides a view of the virtual content from a second perspective (e.g., a second viewpoint), wherein the portal 440b obscures at least a portion of the representation of the physical environment 400b of the second electronic device 101b. In some examples, when the virtual content 422 is displayed via the first application 420, the content is displayed by the respective electronic device (e.g., 120a and/or 120b) within the respective representation of the physical environment 400a-400b without a portal, such as shown for instance in FIG. 4E with respect to the second electronic device 120b. In some examples, the virtual content 422 is displayed in a manner which simulates that the virtual content is in the respective physical environment 400a-400b of one or more of the respective electronic devices 120a-120b. In some examples, the virtual content 422 is displayed in a manner which simulates that the virtual content and a visual representation 414b of the second user is present in the representation of the physical environment 400a of the first electronic device 101a, and the virtual content and a visual representation 414a of the first user is present in the representation of the physical environment 400b of the second electronic device 101b, without the use of one or more portals.

In some examples, while the first electronic device 101a is displaying the virtual content via first application 420, when the first electronic device detects an input from the first user corresponding to a first operation, such as manipulating a portion of the virtual content within in the first application 420, via the hand 404a of the first user, the first electronic device 101a performs the function corresponding to manipulating at least a portion of the virtual content. For instance, as shown in FIG. 4G-FIG. 4I, the first electronic device 101a detects input corresponding to the hand 404a of the first user moving a virtual chess piece. In accordance with receiving the input to move the chess piece within the virtual content, the first electronic device 101a moves the chess piece according to the input. In some examples, while detecting the hand 404a of the first user, the first electronic device 101a shares a representation of the hand 405a of the first user (e.g., data corresponding to one or more images of the hand 404a) with the second electronic device 101b, and the second electronic device optionally displays, within the virtual content, the representation of the hand 405a of the first user and/or the moving of the chess piece to simulate the first and second users sitting across from each other participating in the chess game. Similarly, when the second electronic device 101b detects input corresponding to the hand 404b of the second user moving a chess piece, in accordance with receiving the input to move the chess piece within the virtual content, the second electronic device 101b moves the chess piece according to the input. In some examples, while detecting the hand 404b of the second user, the second electronic device 101b shares a representation of the hand 404b of the second user (e.g., data corresponding to one or more images of the hand 404b) with the first electronic device 101a, and the first electronic device 101a optionally displays, within the virtual content, the representation of the hand 404b of the second user.

In some examples, while the virtual content is displayed via the first application 420 at an electronic device, a user at the respective electronic device is able to move the first application 420 (e.g., the window corresponding to the first application) and/or manipulate the view of the virtual content within the respective portal. Sharing the virtual content in a manner which allows the recipient of the request (e.g., first user at first electronic device 101a) to perform operations to directly modify virtual content (e.g., manipulate chess pieces) within their respective portal in an “interactive mode”. For example, while a chess game is displayed via the first application 420 at the first electronic device 101a, such as shown in FIG. 4I, when the first electronic device 101a detects the hand 404a of the first user providing an input directed to grabber bar 442a of the window of the first application 420, the first electronic device 101a performs one or more operations directed to the window of the first application (e.g., move, rescale, rotate and/or close operations) while optionally maintaining the view within the first application 420 of the chess board. Additionally or alternatively, when the first electronic device 101a detects the hand 404a of the first user providing an input corresponding to manipulation of grabber bar 444a (e.g., or similar or alternative user interface element) associated with the virtual content of the portal 440a, the first electronic device 101a performs one or more operations involving updating the view of the chess board within the first application 420. For example, as shown in FIG. 4I-FIG. 4J, the first electronic device 101a detects the hand 404a of the first user providing an input directed to the grabber bar 444a associated with the virtual content of the portal 440a, wherein the input corresponds to a request to change (e.g., rotate) the view of the virtual content (e.g., the chess board) within the portal 440a. In some examples, in response to detecting the input provided by the hand 404a, the first electronic device 101a optionally rotates the chess board within the portal 440a from a first view (e.g., in FIG. 4I) to a second view (e.g., in FIG. 4J) in accordance with the movement of the hand 404a. Additionally or alternatively, when the view of the virtual content within the portal 440a at the first electronic device 101a is changed, the first electronic device optionally shares the update of the view of the chess board with the second electronic device 101b, and the second electronic device 101b optionally updates the view of the chess board displayed within the portal 440b at the second electronic device 101b. In some examples, the updating of the view of the virtual content within the portal as described above is dependent upon predetermined settings, and/or input detected at the second electronic device allowing the update to the view of the chess board at the portal 440b.

In some examples, when a request is received by a first electronic device, from a second electronic device, to display virtual content corresponding to a first application, and the first electronic device is unable to display the virtual content via the first application (e.g., the first electronic device does not have access to the first application, the first electronic device has not downloaded the first application, etc.), the first electronic device is able to display the virtual content via a second application (e.g., the communication application that is facilitating the communication session between the first electronic device 101a and the second electronic device 101b) with limited functionality to perform first operations corresponding to direct manipulations of the virtual content in a “spectator mode”. For instance, when the request described previously above is received from the second electronic device, and while the first electronic device is displaying the request 434 (as shown in FIG. 4K), the first electronic device receives an input (e.g., gesture from the hand 404a of the first user) corresponding to a selection of the user interface element 436a corresponding to accepting the request. In some examples, as shown in FIG. 4L, in response to receiving the input provided by the hand 404a, the first electronic device 101a optionally displays the shared virtual content via a second application 450 at the first electronic device, which includes a representation of the virtual content 452, while the virtual content is displayed via the first application 420 at the second electronic device 101b. When displaying the representation of the virtual content 452 via the second application 450, the appearance of the representation of the virtual content 452 is optionally different than that of the virtual content 422 as viewed via the first application 420 at the second electronic device 101b. For instance, as illustrated in FIG. 4L, the view offered by the representation of the virtual content 452 displayed at the first electronic device 101a includes a top-down two dimensional view, and the view of the virtual content 422 displayed at the second electronic device 101b is a three-dimensional perspective view. In some examples, as shown in FIG. 4L, the view of the representation of the virtual content 452 displayed via the second application 450 optionally includes textual identifiers (e.g., 1-8) for horizontal rows, commonly referred to as “files”, and textual identifiers (e.g., a-h) for vertical rows, commonly referred to as “ranks”.

In some examples, as illustrated in FIG. 4K, when the request 434 to share is received by the first electronic device 101a, and the first electronic device does not have the first application available (e.g., not open, and/or not downloaded), the first electronic device optionally displays the request with selectable user interface elements which correspond to watching, without allowing interaction with, the representation of the virtual content 452 wherein the representation of the virtual content 452 simulates the view as shown when the virtual content 422 is displayed via the first application 420 as displayed by the second electronic device 101b for instance. In accordance with receiving an input corresponding to watching the virtual content without interacting, the first electronic device 101a optionally displays representation of the virtual content 452 which corresponds to the view of the virtual content 422 as displayed at the second electronic device 101b via the first application 420. In some examples, the request 434 is also received by a third electronic device and a fourth electronic device. When the first application 420 is available at the third electronic device and the fourth electronic device, and the third electronic device and the fourth electronic device accept the request to share, the viewpoints of the third electronic device and the fourth electronic device within a portal optionally correspond to predetermined locations within a template. When the template includes four locations for interacting electronic devices which are participating in the virtual content (e.g., a 4 player board game), and the first electronic device accepts the request 434 to spectate the virtual content via the second application 450, the first electronic device 101a optionally displays a viewpoint corresponding to the unoccupied location (e.g., not displayed from the respective viewpoint) by the second electronic device, the third electronic device, or the fourth electronic device. When the first electronic device accepts the request 434 to watch the virtual content via the first application 420, the first device optionally allows the user at the first electronic device to select and/or switch between viewpoints corresponding to unoccupied locations and/or occupied locations within the template. In some examples, first electronic device 101a optionally displays a representation of the virtual content (e.g., spectator mode) which does not correspond with a viewpoint from a predetermined location within a template, and optionally displays the template and where (e.g., location and/or orientation) within the template one or more participating devices correspond to.

In some examples, the second user 402b at the second electronic device 101b and/or a developer of the first application 420 optionally determines (e.g., via an Application Programming Interface (API)) if the first application supports and/or allows the first electronic device 101a to watch the virtual content 422 (e.g., display a representation of the virtual content 452) via a second application 450, different than the first application which corresponds to the virtual content. In some examples, the developer of the first application optionally determines, via an API, if the first application supports the sharing of virtual content corresponding to Digital Rights Management (DRM) content (e.g., copyrighted videos, books, works of art, etc.). In some examples, the first application does not allow the sharing of virtual content corresponding to DRM content. Additionally or alternatively, the first application optionally does not allow the sharing of virtual content corresponding to DRM content to electronic devices which are outside an approved location (e.g., country). In some examples, the API controls whether the virtual content is able to be displayed (e.g., a representation of the virtual content) via a second application, other than the first application to which the virtual content corresponds.

Additionally or alternatively, in some examples, when the virtual content is shared via the first application, the virtual content is optionally shared in some cases (e.g., with the first electronic device) in an interactive mode, and optionally shared in other cases (e.g., with a third electronic device) in a spectator mode. By allowing the sharing electronic device to selectively share the virtual content in an interactive mode or spectator mode, the sharing electronic device controls which invited participants (first user at the first electronic device, third user at a third electronic device, etc.) are able to modify and/or manipulate the virtual content. For example when playing a virtual chess game, two electronic devices are able to move the chess pieces (e.g., first electronic device and second electronic device) while other electronic devices (third electronic device, fourth electronic device, etc.) are able to spectate the game. Additionally or alternatively, the second electronic device optionally shares virtual content corresponding to a presentation wherein certain electronic devices are provided permissions to update the virtual content in the interactive mode, while other electronic devices are provided permissions to only view the virtual content in the spectator mode. In some examples, the first electronic device is able to initiate sharing of virtual content with a predetermined group corresponding to a plurality of electronic devices.

In some examples, while the first electronic device is in a communication session with the second electronic device, when the second electronic device initiates sharing the virtual content, in response to the second electronic device sharing the virtual content, the first electronic device displays the virtual content without displaying a request 434 and/or awaiting input from the first user at the first electronic device. The behavior corresponding to the first electronic device displaying a request and receiving an input accepting the request prior to displaying the shared virtual content is optionally dependent upon predetermined settings set by the user and/or the developer.

In some examples, when the virtual content is shared from the second electronic device 101b to the first electronic device 101a, displaying the virtual content at the first electronic device includes displaying the virtual content within the portal 440b from a viewpoint corresponding to the viewpoint of the second electronic device, and/or displaying the viewpoint of the second electronic device in the three-dimensional environment. In some examples, as shown in FIG. 4L, the first electronic device 101a displays a representation of the virtual chess game via the second application 450 (e.g., the communication application, or screensharing application) in a top-down view, while the second electronic device 101b displays the virtual chess game via the first application in a perspective (e.g., side) three-dimensional view via the first application 420 (e.g., a virtual chess application).

When the virtual content is shared at the first electronic device 101a via the second application 450 (e.g., different from the application used to display the virtual content at the second electronic device), the first user at the first electronic device 101a is optionally unable to interact directly with the virtual content. In some examples, the second application 450 corresponds to a screensharing application that enables the first user 402a at the first electronic device 101a to view the shared virtual content without interacting with the shared virtual content. Accordingly, when the virtual content is shared via the second application 450, the first electronic device 101a displays the virtual content in a capacity wherein the first user is able to perform operations at the first electronic device 101a which do not directly change and/or augment the virtual content as shown at the first electronic device 101a and the second electronic device 101b. Inputs directed to the virtual content via the second application 450 optionally do not result in changes and/or augmentation of the virtual content at the first electronic device 101a or at the second electronic device 101b as they would be performed when the virtual content is shared and displayed via the first application 420 at both electronic devices. For instance, when the virtual content corresponding to a chess game is shared via a second application 450, such as shown in FIG. 4L, when the first electronic device 101a detects an input (e.g., from the hand 404a of the first user) corresponding to an operation to move a chess piece, the chess piece is not moved in the second application 450 at the first electronic device 101a, and the chess piece is therefore not moved at the second electronic device 101b within the first application 420. Additionally or alternatively, when the first electronic device 101a detects the hand 404a of the first user, the first electronic device 101a optionally does not share data corresponding to the detected movements of the hand 404a of the first user 402a with the second electronic device 101b, and the second electronic device optionally does not display a representation of the hand of the first user within the portal 440b at the second electronic device 101b. Additionally or alternatively, when the virtual content is shared and displayed via the second application 450 at the first electronic device 101a, and the first electronic device 101a detects inputs from the first user corresponding to operations which correspond with indirect interactions with the shared virtual content, such as viewpoint changes (e.g., pan, tilt, and/or zoom), the first electronic device 101a optionally performs the operations at the first electronic device 101a, without changing and/or augmenting the virtual content. For instance, when the virtual content is shared and displayed at the first electronic device 101a via the second application 450, and the first electronic device 101a detects inputs from the first user corresponding with viewpoint changes, the virtual content displayed at the first electronic device 101a is optionally updated according to the detected inputs, wherein the viewpoint changes made at the first electronic device 101a within the second application 450 are not reflected in the first application 420 at the second electronic device 101b.

In some examples, although operations such as direct manipulations to the virtual content are not able to be performed via the second application 450 at the first electronic device 101a, the first electronic device allows indirect modifications to the virtual content. For instance, as illustrated in FIG. 4L-FIG. 4N, while the virtual content is shared via a second application 450, the second application 450 optionally provides the ability to enter information and/or a request to indirectly modify the virtual content. In some examples, when the first electronic device 101a is displaying a chess game via the second application 450, the second application includes a user interface element 426 corresponding to a chat functionality. As shown in FIG. 4M, the first electronic device 101a detects an input directing the movement of a chess piece, such as entering text “Pc2 to c4” into a chat user interface element 454 which corresponds to instructions to move the to move the pawn at board location c2 to board location c4 optionally followed by an input corresponding to executing the move (e.g., gesture of the hand 404a of the first user directed to user interface element 456). When the first electronic device 101a detects such input, the instructions are optionally sent to the second electronic device 101b. When the second electronic device 101b receives the input directing the movement of the pawn from c2 to c4, the second electronic device 101b optionally moves the pawn from c2 to c4 (e.g., in accordance with input provided by the second user for moving the pawn from c2 to c4 based on the instructions received from the first electronic device 101a). When the second electronic device updates the location of the pawn from c2 to c4, the second electronic device shares the movement of the chess piece with the first electronic device, and the first electronic device updates the display of the representation of the virtual chess game to reflect the updated location of the pawn from c2 to c4 accordingly.

Additionally or alternatively, while the virtual content is displayed via the first application 420 at the second electronic device 101b, and shared via the second application 450 at the first electronic device 101a (FIG. 4N-FIG. 4O), and the second electronic device 101b detects an input (e.g., gesture from the hand 404b of the second user) to manipulate the virtual content, the operation to manipulate the virtual content corresponding to the input is performed at the second electronic device 101b within the portal 440b, and shared with the first electronic device 101a to update the view of the virtual content within the second application 450 at the first electronic device 101a according to the manipulation.

In some examples, when an input is received (e.g., from the first user at the first electronic device 101a) which corresponds to a rejection of the request (e.g., input directed to user interface element 436b in FIG. 4K) to display virtual content within the three-dimensional environment, the first electronic device 101a does not display and/or participate in the shared content from the second electronic device 101b (e.g., via the second application 450). In some examples, when an input is received at the first electronic device 101a rejecting the request to display virtual content received from the second electronic device, the second electronic device 101b continues to display the virtual content within the three-dimensional environment at the second electronic device 101b, however the virtual content is optionally not visible at the first electronic device 101a. For instance, when a plurality of electronic devices is participating in the three-dimensional environment including a first electronic device, a second electronic device, and a third electronic device, the first electronic device and the third electronic device receive a request from the second electronic device to share virtual content within the shared three-dimensional environment. When an input is received at the first electronic device rejecting the request to share virtual content within the three-dimensional environment, and an input is received at the third electronic device accepting the request to share virtual content, the virtual content is optionally shared within the shared three-dimensional environment and is visible to the third electronic device within the three-dimensional environment, while the virtual content is not visible to the first electronic device within the shared three-dimensional environment. In some examples, subsequent to an input being received at the first electronic device rejecting the request to display virtual content within the three-dimensional environment, a user interface element (e.g., a selectable icon) is displayed within the three-dimensional environment at the first electronic device which allows a user at the first electronic device to later accept the request (e.g., opt into viewing the virtual content) based on an input subsequent to the input rejecting the request.

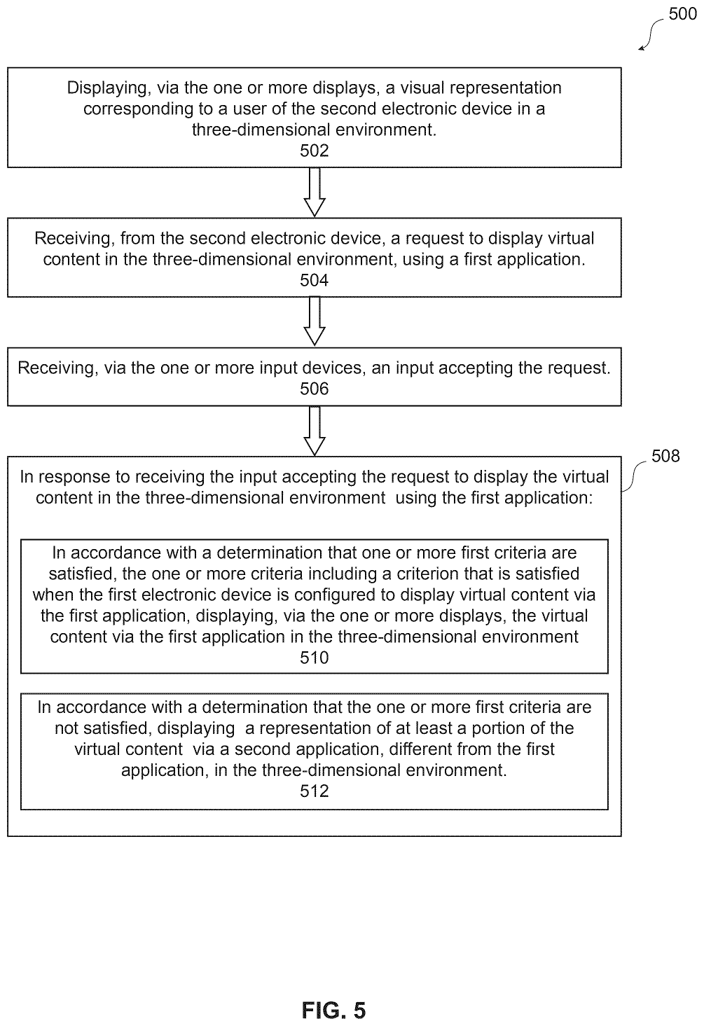

In some examples, a first electronic device (101a) in communication with a second electronic device (101b) is configured to perform a method 500 as shown in FIG. 5. In some examples, the first electronic device and the second electronic device are optionally a head-mounted display similar or corresponding to electronic devices 260 and 270 of FIG. 2A-2C and/or electronic device 101 of FIG. 1. Method 500 includes displaying (at 502) via the one or more displays (e.g., display 120a in FIG. 4E), a visual representation corresponding to a user of the second electronic device (e.g., visual representation 414a of the first user 402a in FIG. 4C) in a three-dimensional environment (e.g., representation of the physical environment 400a of the first electronic device 101a in FIG. 4C). Method 500 also includes, receiving (at 506), from the second electronic device (e.g., 101b in FIG. 4E), a request to display virtual content in the three-dimensional environment (e.g., representation of the physical environment 400a of the first electronic device 101a in FIG. 4E), using a first application (e.g., 420 in FIG. 4E), and in accordance with a determination that one or more first criteria are satisfied, the one or more criteria including a criterion that is satisfied when the first electronic device (e.g., 101a in FIG. 4G) is configured to display virtual content (e.g., 422 in FIG. 4G) via the first application (e.g., 420 in FIG. 4G), displaying (at 510), via the one or more displays (e.g., display 120a in FIG. 4G), the virtual content via the first application in the three-dimensional environment. Additionally or alternatively, method 500 also includes, in accordance with a determination that the one or more first criteria are not satisfied, displaying (at 512) a representation (e.g., representation of the virtual content 452 in FIG. 4L) of at least a portion of the virtual content (452) via a second application (e.g., second application 450 in FIG. 4L), different from the first application (e.g., first application 420 in FIG. 4L), in the three-dimensional environment (e.g., representation of the physical environment 400a of the first electronic device in FIG. 4L).

It is understood that method 500 is an example and that more, fewer, or different operations can be performed in the same or in a different order. Additionally, the operations in method 500 described above are, optionally, implemented by running one or more functional modules in an information processing apparatus such as general-purpose processors (e.g., as described with respect to FIG. 2A-2C) or application specific chips, and/or by other components of FIG. 2A-2C.

Although many examples illustrated include virtual content displayed via the first application within a portal, it is understood that in some examples, the virtual content, visual representation of the first user, and/or visual representation of the second user are displayed by the respective electronic device (e.g., 120a and/or 120b) within the respective representation of the physical environment without a portal (e.g., as illustrated in FIG. 4E with respect to the second electronic device 120b).

Therefore, according to the above, some examples of the disclosure are directed to a method. The method optionally comprises, at a first electronic device in communication with a one or more displays, one or more input devices, and a second electronic device: while in a communication session with the second electronic device, displaying, via the one or more displays, a visual representation corresponding to a user of the second electronic device in a three-dimensional environment; while displaying the visual representation corresponding to the user of the second electronic device in the three-dimensional environment, receiving, from the second electronic device, a request to display virtual content in the three-dimensional environment, using a first application; after receiving the request from the second electronic device, receiving, via the one or more input devices, an input accepting the request; and in response to receiving the input accepting the request to display the virtual content in the three-dimensional environment using the first application: in accordance with a determination that one or more first criteria are satisfied, the one or more criteria including a criterion that is satisfied when the first electronic device is configured to display virtual content via the first application, displaying, via the one or more displays, the virtual content via the first application in the three-dimensional environment; and in accordance with a determination that the one or more first criteria are not satisfied, displaying a representation of at least a portion of the virtual content via a second application, different from the first application, in the three-dimensional environment. In some examples, when the first electronic device and the second electronic device are not in a communication session, and the second electronic device shares the virtual content with the first electronic device, the first electronic device receives a request to share the virtual content, wherein the acceptance of the request at the first electronic device results in establishing communication between the first electronic device and the second electronic device in accordance with the sharing of the virtual content.

Additionally or alternatively to the one or more examples disclosed above, in some examples, the method further comprises: after receiving the request from the second electronic device, receiving, via the one or more input devices, an input rejecting the request; and in accordance with receiving the input rejecting the request to display the virtual content in the three-dimensional environment, forgoing displaying the virtual content in the three-dimensional environment.

Additionally or alternatively to the one or more examples disclosed above, in some examples, displaying the virtual content via the first application comprises displaying the virtual content within a portal in the three-dimensional environment via the first application, and wherein displaying the representation of at least a portion of the virtual content via the second application comprises displaying the virtual content is shared within a portal in the three-dimensional environment via the second application.

Additionally or alternatively to the one or more examples disclosed above, in some examples, the method further comprises, while displaying the virtual content within the portal via the first application, receiving one or more inputs directed to the virtual content; and in response to receiving the one or more inputs directed to the virtual content, performing one or more operations within the portal corresponding to the one or more inputs directed to the virtual content.

Additionally or alternatively to the one or more examples disclosed above, in some examples, the method further comprises, while displaying the representation of at least a portion of the virtual content within a portal via the second application, receiving one or more inputs corresponding to a first functionality directed to the representation of at least a portion of the virtual content; and in response to receiving the one or more inputs corresponding to a first functionality directed to the representation of at least a portion of the virtual content, forgoing performing one or more operations within the portal corresponding to the first functionality.

Additionally or alternatively to the one or more examples disclosed above, in some examples, the method further comprises, while displaying the representation of at least a portion of the virtual content within the portal via the second application, and receiving the one or more inputs corresponding to a second functionality, different than the first functionality, directed to the representation of at least a portion of the virtual content, correspond with a second functionality, different than the first functionality, performing one or more operations within the portal corresponding to the second functionality.

Additionally or alternatively to the one or more examples disclosed above, in some examples, displaying the virtual content includes displaying a portion of a second three-dimensional environment corresponding to a user of the second electronic device; and a representation of the user of the second electronic device at least partially obscuring the second three-dimensional environment.

Additionally or alternatively, in some examples, displaying the virtual content via the first application comprises displaying the virtual content within a portal in the three-dimensional environment via the first application.

Additionally or alternatively to the one or more examples disclosed above, in some examples, the method further comprises, displaying a representation of at least a portion of the virtual content within the three-dimensional environment via the second application includes displaying a first user interface element that obscures at least a portion of the three-dimensional environment.

Additionally or alternatively to the one or more examples disclosed above, in some examples, the method further comprises,
displaying the virtual content in the three-dimensional environment using via the first application includes displaying the virtual content from a first perspective from a viewpoint of a first user at the first electronic device, the method further comprising; and the method further comprises, in accordance with receiving an input vie the one or more input devices, corresponding with a request to display the virtual content from a second perspective from the viewpoint of the first user, displaying the virtual content from the second perspective from the viewpoint of the first user.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

What is claimed is:

1. A method comprising:
at a first electronic device in communication with a one or more displays, one or more input devices, and a second electronic device:
while in a communication session with the second electronic device, displaying, via the one or more displays, a visual representation corresponding to a user of the second electronic device in a three-dimensional environment;
while displaying the visual representation corresponding to the user of the second electronic device in the three-dimensional environment, receiving, from the second electronic device, a request to display virtual content in the three-dimensional environment, using a first application;
after receiving the request from the second electronic device, receiving, via the one or more input devices, an input accepting the request; and
in response to receiving the input accepting the request to display the virtual content in the three-dimensional environment using the first application:
in accordance with a determination that one or more first criteria are satisfied, the one or more first criteria including a criterion that is satisfied when the first electronic device is configured to display virtual content via the first application, displaying, via the one or more displays, the virtual content via the first application in the three-dimensional environment; and
in accordance with a determination that the one or more first criteria are not satisfied, displaying a representation of at least a portion of the virtual content via a second application, different from the first application, in the three-dimensional environment.

2. The method of claim 1, further comprising, after receiving the request from the second electronic device, receiving, via the one or more input devices, an input rejecting the request; and
in accordance with receiving the input rejecting the request to display the virtual content in the three-dimensional environment, forgoing displaying the virtual content in the three-dimensional environment.

3. The method of claim 1, wherein displaying the virtual content via the first application comprises displaying the virtual content in the three-dimensional environment via the first application, and wherein displaying the representation of at least a portion of the virtual content via the second application comprises displaying the virtual content within a portal in the three-dimensional environment via the second application.

4. The method of claim 3, further comprising, while displaying the virtual content via the first application, receiving one or more inputs directed to the virtual content; and
in response to receiving the one or more inputs directed to the virtual content, performing one or more operations corresponding to the one or more inputs directed to the virtual content.

5. The method of claim 3, further comprising, while displaying the representation of at least a portion of the virtual content via the second application, receiving one or more inputs corresponding to a first functionality directed to the representation of at least a portion of the virtual content; and
in response to receiving the one or more inputs corresponding to a first functionality directed to the representation of at least a portion of the virtual content, forgoing performing one or more operations corresponding to the first functionality.

6. The method of claim 3, wherein displaying the virtual content includes displaying:
a portion of a second three-dimensional environment corresponding to the user of the second electronic device; and
a representation of the user of the second electronic device at least partially obscuring the second three-dimensional environment.

7. The method of claim 3, wherein displaying the virtual content via the first application comprises displaying the virtual content within a portal in the three-dimensional environment via the first application.

8. The method of claim 1, wherein displaying the virtual content in the three-dimensional environment via the first application includes displaying the virtual content from a first perspective from a viewpoint of a first user at the first electronic device, the method further comprising:
in accordance with receiving an input vie the one or more input devices, corresponding with a request to display the virtual content from a second perspective from the viewpoint of the first user, displaying the virtual content from the second perspective from the viewpoint of the first user.

9. A first electronic device comprising:
one or more displays;
one or more input devices; and
processing circuitry configured to:
while in a communication session with a second electronic device, display, via the one or more displays, a visual representation corresponding to a user of the second electronic device in a three-dimensional environment;
while displaying the visual representation corresponding to the user of the second electronic device in the three-dimensional environment, receive, from the second electronic device, a request to display virtual content in the three-dimensional environment, using a first application;
after receiving the request from the second electronic device, receive, via the one or more input devices, an input accepting the request; and
in response to receiving the input accepting the request to display the virtual content in the three-dimensional environment, use the first application:
in accordance with a determination that one or more first criteria are satisfied, the one or more first criteria including a criterion that is satisfied when the first electronic device is configured to display virtual content via the first application, display, via the one or more displays, the virtual content via the first application in the three-dimensional environment; and
in accordance with a determination that the one or more first criteria are not satisfied, display a representation of at least a portion of the virtual content via a second application, different from the first application, in the three-dimensional environment.

10. The first electronic device of claim 9, the processing circuitry further configured to, after receiving the request from the second electronic device, receive, via the one or more input devices, an input rejecting the request; and
in accordance with receiving the input rejecting the request to display the virtual content in the three-dimensional environment, forgo displaying the virtual content in the three-dimensional environment.

11. The first electronic device of claim 9, wherein displaying the virtual content via the first application comprises displaying the virtual content in the three-dimensional environment via the first application, and wherein displaying the representation of at least a portion of the virtual content via the second application comprises displaying the virtual content within a portal in the three-dimensional environment via the second application.

12. The first electronic device of claim 11, the processing circuitry further configured to, while displaying the virtual content via the first application, receive one or more inputs directed to the virtual content; and
in response to receiving the one or more inputs directed to the virtual content, perform one or more operations corresponding to the one or more inputs directed to the virtual content.

13. The first electronic device of claim 11, the processing circuitry further configured to, while displaying the representation of at least a portion of the virtual content via the second application, receive one or more inputs corresponding to a first functionality directed to the representation of at least a portion of the virtual content; and
in response to receiving the one or more inputs corresponding to a first functionality directed to the representation of at least a portion of the virtual content, forgo performing one or more operations corresponding to the first functionality.

14. The first electronic device of claim 11, wherein displaying the virtual content includes displaying:
a portion of a second three-dimensional environment corresponding to the user of the second electronic device; and
a representation of the user of the second electronic device at least partially obscuring the second three-dimensional environment.

15. The first electronic device of claim 11, wherein displaying the virtual content via the first application comprises displaying the virtual content within a portal in the three-dimensional environment via the first application.

16. The first electronic device of claim 9, wherein displaying the virtual content in the three-dimensional environment via the first application includes displaying the virtual content from a first perspective from a viewpoint of a first user at the first electronic device, the processing circuitry further configured to:
in accordance with receiving an input vie the one or more input devices, corresponding with a request to display the virtual content from a second perspective from the viewpoint of the first user, display the virtual content from the second perspective from the viewpoint of the first user.

17. A non-transitory computer readable storage medium storing instructions, which when executed by a first electronic device including one or more displays, and one or more input devices, and processing circuitry, cause the processing circuitry to:
while in a communication session with a second electronic device, display, via the one or more displays, a visual representation corresponding to a user of the second electronic device in a three-dimensional environment;
while displaying the visual representation corresponding to the user of the second electronic device in the three-dimensional environment, receive, from the second electronic device, a request to display virtual content in the three-dimensional environment, using a first application;
after receiving the request from the second electronic device, receive, via the one or more input devices, an input accepting the request; and
in response to receiving the input accepting the request to display the virtual content in the three-dimensional environment, use the first application:
in accordance with a determination that one or more first criteria are satisfied, the one or more first criteria including a criterion that is satisfied when the first electronic device is configured to display virtual content via the first application, display, via the one or more displays, the virtual content via the first application in the three-dimensional environment; and
in accordance with a determination that the one or more first criteria are not satisfied, display a representation of at least a portion of the virtual content via a second application, different from the first application, in the three-dimensional environment.

18. The non-transitory computer readable storage medium of claim 17, the instructions further cause the processing circuitry to, after receiving the request from the second electronic device, receive, via the one or more input devices, an input rejecting the request; and
in accordance with receiving the input rejecting the request to display the virtual content in the three-dimensional environment, forgo displaying the virtual content in the three-dimensional environment.

19. The non-transitory computer readable storage medium of claim 17, wherein displaying the virtual content via the first application comprises displaying the virtual content in the three-dimensional environment via the first application, and wherein displaying the representation of at least a portion of the virtual content via the second application comprises displaying the virtual content within a portal in the three-dimensional environment via the second application.

20. The non-transitory computer readable storage medium of claim 19, the instructions further cause the processing circuitry to, while displaying the virtual content via the first application, receive one or more inputs directed to the virtual content; and
in response to receiving the one or more inputs directed to the virtual content, perform one or more operations corresponding to the one or more inputs directed to the virtual content.

21. The non-transitory computer readable storage medium of claim 19, the instructions further cause the processing circuitry to, while displaying the representation of at least a portion of the virtual content via the second application, receive one or more inputs corresponding to a first functionality directed to the representation of at least a portion of the virtual content; and
in response to receiving the one or more inputs corresponding to a first functionality directed to the representation of at least a portion of the virtual content, forgo performing one or more operations corresponding to the first functionality.

22. The non-transitory computer readable storage medium of claim 19, wherein displaying the virtual content includes displaying:
a portion of a second three-dimensional environment corresponding to the user of the second electronic device; and
a representation of the user of the second electronic device at least partially obscuring the second three-dimensional environment.

23. The non-transitory computer readable storage medium of claim 19, wherein displaying the virtual content via the first application comprises displaying the virtual content within a portal in the three-dimensional environment via the first application.

24. The non-transitory computer readable storage medium of claim 17, wherein displaying the virtual content in the three-dimensional environment via the first application includes displaying the virtual content from a first perspective from a viewpoint of a first user at the first electronic device, the instructions further cause the processing circuitry to:
in accordance with receiving an input vie the one or more input devices, corresponding with a request to display the virtual content from a second perspective from the viewpoint of the first user, display the virtual content from the second perspective from the viewpoint of the first user.
